(19) United States
(12) Patent Application Publication
(10) Pub. No.: US 2026/0050709 A1
(43) Pub. Date: Feb. 19, 2026

(54) DATA GENERATION METHOD AND DATA GENERATION PROGRAM

(71) Applicant: Fujitsu Limited, Kawasaki-shi (JP)

(72) Inventors: Asako KITAURA, Kawasaki (JP); Eigo SEGAWA, Kawasaki (JP)

(73) Assignee: Fujitsu Limited, Kawasaki-shi (JP)

(21) Appl. No.: 19/369,915

(22) Filed: Oct. 27, 2025

Related U.S. Application Data
(63) Continuation of application No. PCT/JP2024/009461, filed on Mar. 12, 2024.

(30) Foreign Application Priority Data
Apr. 28, 2023 (JP) 2023-074425

(51) Int. Cl. G06F 30/20; G06F 111/08

(52) U.S. Cl. CPC G06F 30/20; G06F 2111/08

(57) ABSTRACT

A data generation method, executed by a computer, for generating data to be used in a simulation includes identifying, by the computer, a travel type of a traveler who visits a target area of the simulation by referencing statistical data; adding, by the computer, information indicating a place where the traveler stays in the target area, identified according to the travel type of the traveler, to human attribute data of the traveler; and adding, by the computer, the human attribute data of the traveler, to which the information indicating the place where the traveler stays is added, to a human attribute data group of residents of the target area, the human attribute data group being used in the simulation.

### CROSS-REFERENCE TO RELATED APPLICATIONS

This application is a continuation of International Application No. PCT/JP2024/009461, filed on Mar. 12, 2024 and designating the U.S., which claims priority to Japanese Patent Application No. 2023-074425, filed on Apr. 28, 2023. The contents of these applications are incorporated herein by reference in their entirety.

### FIELD

The present disclosure relates to a data generation method and a data generation program.

### BACKGROUND

In recent years, a people flow simulation for estimating movement statuses of people is known as one type of social simulations conducted in relation to social issues. In this simulation, synthetic population data mainly consisting of residents of each area is used. The synthetic population data is a human data group obtained by using statistical data of residents obtained by a census and the like to virtually reproduce the residents.

### RELATED-ART DOCUMENTS

### Patent Documents

[Patent Document 1] Japanese Laid-open Patent Publication No. 2008-243130
[Patent Document 2] Japanese Laid-open Patent Publication No. 2017-219996
[Patent Document 3] Japanese Laid-open Patent Publication No. 2019-179320

### SUMMARY

According to an embodiment of the present disclosure, a data generation method, executed by a computer, for generating data to be used in a simulation includes identifying, by the computer, a travel type of a traveler who visits a target area of the simulation by referencing statistical data; adding, by the computer, information indicating a place where the traveler stays in the target area, identified according to the travel type of the traveler, to human attribute data of the traveler; and adding, by the computer, the human attribute data of the traveler, to which the information indicating the place where the traveler stays is added, to a human attribute data group of residents of the target area, the human attribute data group being used in the simulation.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an overview of a simulation;

FIG. 2 is a diagram illustrating an example of a hardware configuration of an information processing apparatus;

FIG. 3 is a diagram illustrating a functional configuration of the information processing apparatus;

FIG. 4 is a flowchart illustrating an operation of the information processing apparatus;

FIG. 5 is a diagram illustrating functions of a synthetic population data generation unit;

FIG. 6 is a first diagram illustrating generation of first synthetic population data;

FIG. 7 is a second diagram illustrating the generation of the first synthetic population data;

FIG. 8 is a third diagram illustrating the generation of the first synthetic population data;

FIG. 9 is a diagram illustrating functions of a second generation unit;

FIG. 10 is a first diagram illustrating selection lists;

FIG. 11 is a second diagram illustrating the selection lists;

FIG. 12A is a diagram illustrating transportation data;

FIG. 12B is a diagram illustrating transportation data; and accommodation facility data;

FIG. 13 is a diagram illustrating an example of first synthetic population data corresponding to a traveler;

FIG. 14 is a diagram illustrating an example of second synthetic population data;

FIG. 15 is a flowchart illustrating a process performed by the synthetic population data generation unit;

FIG. 16 is a first diagram illustrating generation of second synthetic population data; and

FIG. 17 is a second diagram illustrating the generation of the second synthetic population data.

### DESCRIPTION OF EMBODIMENTS

Synthetic population data used in a conventional people flow simulation as described above does not include data relating to travelers who visit an area to be simulated. Therefore, conventionally, if a people flow simulation is performed on an area where there are many travelers, the simulation taking the travelers into account cannot be performed.

According to an embodiment of the present disclosure, a simulation taking travelers into account can be performed.

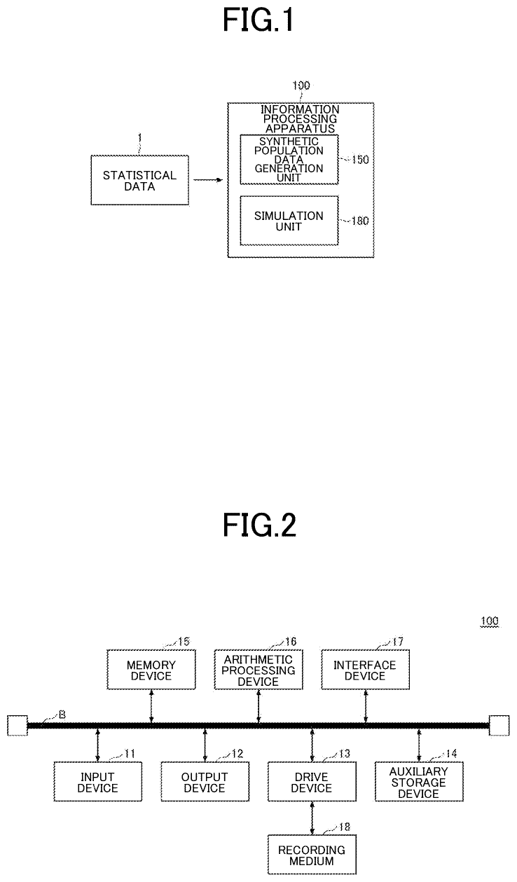

Embodiments will be described below with reference to the drawings. FIG. 1 is a diagram illustrating a people flow simulation.

An information processing apparatus 100 according to an embodiment executes various social simulations. A social simulation refers to, for example, modeling human behaviors and interaction and simulating a social system having uncertainty on a computer. In a social simulation, for each measure of a plurality of measures to address the subject of the simulation, the simulation is repeatedly performed while changing the characteristics of elements having uncertainty with respect to the measure by using random numbers or the like.

Further, in the social simulation, problems of the measures can be extracted and acquired by analyzing the results of the simulation. The more times the simulation is performed, the more cases can be considered, and the possibility of accurately extracting more problems increases.

The information processing apparatus 100 according to the present embodiment will be described as, for example, performing a people flow simulation for estimating movement statuses of people as one type of social simulations.

The information processing apparatus 100 according to the present embodiment mainly includes a synthetic population data generation unit 150 and a simulation unit 180. Other functional units of the information processing apparatus 100 will be described later.

Upon acquiring statistical data 1, the information processing apparatus 100 causes the synthetic population data generation unit 150 to generate synthetic population data of an area to be simulated (hereinafter referred to as a “target area”) from the statistical data 1.

Specifically, the synthetic population data generation unit 150 generates synthetic population data of residents of a target area based on statistical data of the residents of the target area among the statistical data 1.

Further, the synthetic population data generation unit 150 identifies an area including residences of travelers who visited the target area, from statistical data of the travelers included in the statistical data 1. Then, the synthetic population data generation unit 150 acquires synthetic population data corresponding to the travelers from synthetic population data of residents of the identified area.

Further, the synthetic population data generation unit 150 identifies travel types of the travelers from the statistical data 1, and sets, as information indicating pseudo residences of the travelers, information indicating places in the target area based on the travel types of the travelers. The synthetic population data generation unit 150 adds the information indicating the pseudo residences of the travelers to the synthetic population data corresponding to the travelers, thereby obtaining synthetic population data of pseudo residents of the target area.

In the following description, the synthetic population data of the residents of the target area is referred to as first synthetic population data, and the synthetic population data of the pseudo residents of the target area is referred to as second synthetic population data.

The synthetic population data generation unit 150 of the present embodiment acquires, as synthetic population data of the target area, data obtained by adding the second synthetic population data to the first synthetic population data.

Synthetic population data is a human data group obtained by using statistical data of residents obtained by a census or the like to virtually reproduce the residents, and virtual human data for each person includes human attribute data indicating attributes of each person. In other words, the synthetic population data includes a set of virtually reproduced human attribute data.

The human attribute data may include, for example, residence, sex, age group, household type to which a person belongs (single-person household, multiple-person household, or family household), purpose (leisure or visiting acquaintances), place to stay (a hotel or camping), whether the person stays overnight, ownership of a private car, annual household income, and the like.

The statistical data 1 includes, for example, various statistical data such as census results. The statistical data includes, for example, publicly available statistical data and statistical data provided by each municipality. A travel type identified from the statistical data 1 indicates whether a traveler stays overnight in the target area or the traveler is on a day trip in the target area.

Upon generation of synthetic population data of the target area including two kinds of synthetic population data, the information processing apparatus 100 causes the simulation unit 180 to perform a people flow simulation by using the synthetic population data.

That is, the simulation unit 180 performs a people flow simulation by using, as the synthetic population data of the target area, synthetic population data including synthetic population data of residents of the target area and synthetic population data of pseudo residents who are travelers to the target area.

Therefore, in the present embodiment, synthetic population data close to reality in which travelers are taken into account can be generated, and thus the accuracy of the simulation can be improved.

In the example of FIG. 1, the information processing apparatus 100 is one computer, but the present invention is not limited thereto. The information processing apparatus 100 may be executed by a plurality of computers.

A hardware configuration of the information processing apparatus 100 according to the present embodiment will be described below with reference to FIG. 2. FIG. 2 is a diagram illustrating an example of the hardware configuration of the information processing apparatus.

The information processing apparatus 100 according to the present embodiment is a computer including an input device 11, an output device 12, a drive device 13, an auxiliary storage device 14, a memory device 15, an arithmetic processing device 16, and an interface device 17, which are connected to one another via a bus B.

The input device 11 is a device configured to input various kinds of information, and is implemented by, for example, a keyboard, a pointing device, or the like. The output device 12 is configured to output various kinds of information and is implemented by, for example, a display or the like. The interface device 17 includes a LAN card and is used to connect to a network.

A program for implementing the synthetic population data generation unit 150 and the like of the information processing apparatus 100 is at least a part of various programs for controlling the information processing apparatus 100. The program is provided by, for example, distributing a recording medium 18 or by being downloaded from a network. As the recording medium 18 in which the program is recorded, any of various types of storage media can be used, including a recording medium that records information optically, electrically, or magnetically, such as a CD-ROM, a flexible disk, or a magneto-optical disc, and a semiconductor memory which records information electrically, such as a ROM or a flash memory.

When the recording medium 18 in which the program is recorded is set in the drive device 13, the program is installed from the recording medium 18 into the auxiliary storage device 14 via the drive device 13. The program downloaded from the network is installed into the auxiliary storage device 14 via the interface device 17.

The auxiliary storage device 14 implements each storage unit and the like described later, stores the program installed in the information processing apparatus 100, and stores various files, various kinds of data, and the like required by the information processing apparatus 100. The memory device 15 reads out the program from the auxiliary storage device 14 and stores the program when the information processing apparatus 100 is activated. The arithmetic processing device 16 implements various kinds of processes, as will be described later, in accordance with the program stored in the memory device 15.

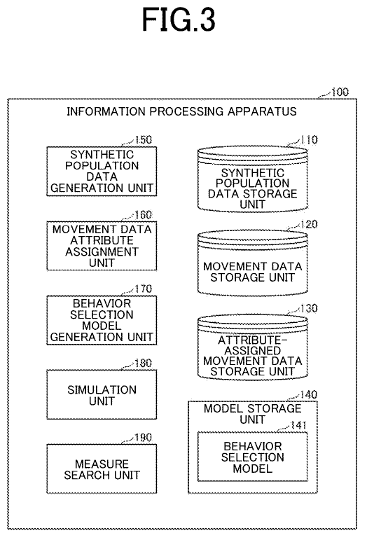

Next, functions of the information processing apparatus 100 according to the present embodiment will be described with reference to FIG. 3. FIG. 3 is a diagram illustrating a functional configuration of the information processing apparatus.

The information processing apparatus 100 according to the present embodiment includes a synthetic population data storage unit 110, a movement data storage unit 120, an attribute-assigned movement data storage unit 130, and a model storage unit 140. Each of the storage units may be implemented by the auxiliary storage device 14 or the like.

Further, the information processing apparatus 100 includes the synthetic population data generation unit 150, a movement data attribute assignment unit 160, a behavior selection model generation unit 170, the simulation unit 180, and a measure search unit 190. Each of these units is implemented by the arithmetic processing device 16 reading out the program from the memory device 15 and executing the program.

The synthetic population data storage unit 110 stores first synthetic population data and second synthetic population data, generated by the synthetic population data generation unit 150, for each area.

The movement data storage unit 120 stores movement data. The movement data may be data including a date indicating a day on which a person moved, a departure place, and a destination. Further, the movement data may be data representing the number of users for each combination of a departure place and a destination. Further, the movement data may be a kind of data on the number of passengers getting on and off public transportation such as a railway, or may be aggregated data indicating “to what destination and in what number passengers who have boarded at a certain place are traveling”. In the present embodiment, it is assumed that the movement data are acquired in advance and stored in the movement data storage unit 120.

The attribute-assigned movement data storage unit 130 stores attribute-assigned movement data obtained by assigning human attribute data to movement data stored in the movement data storage unit 120 based on synthetic population data stored in the synthetic population data storage unit 110. The model storage unit 140 stores a behavior selection model 141.

The synthetic population data generation unit 150 acquires statistical data 1, generates first synthetic population data and second synthetic population data, and stores the first synthetic population data and the second synthetic population data in the synthetic population data storage unit 110. Details of the synthetic population data generation unit 150 will be described later.

The movement data attribute assignment unit 160 acquires, for each movement data, synthetic population data of residents residing in the vicinity of a place indicated by the movement data from the synthetic population data storage unit 110, assigns human attribute data included in the acquired synthetic population data to the movement data, and stores the data as attribute-assigned movement data in the attribute-assigned movement data storage unit 130.

The behavior selection model generation unit 170 receives, as an input, attribute-assigned movement data, generates a behavior selection model 141 by performing training on human behavior selection, and stores the behavior selection model 141 in the model storage unit 140.

Upon a simulation condition being input, the simulation unit 180 acquires attribute-assigned movement data from the attribute-assigned movement data storage unit 130 based on the input simulation condition. Then, the simulation unit 180 inputs the attribute-assigned movement data into the behavior selection model 141, and acquires an output from the behavior selection model 141. In other words, the simulation unit 180 performs a simulation by using the behavior selection model 141.

The measure search unit 190 is a model that searches for an optimal measure from simulation results obtained by the simulation unit 180 according to a predetermined measure selection method and outputs the searched result as a measure candidate.

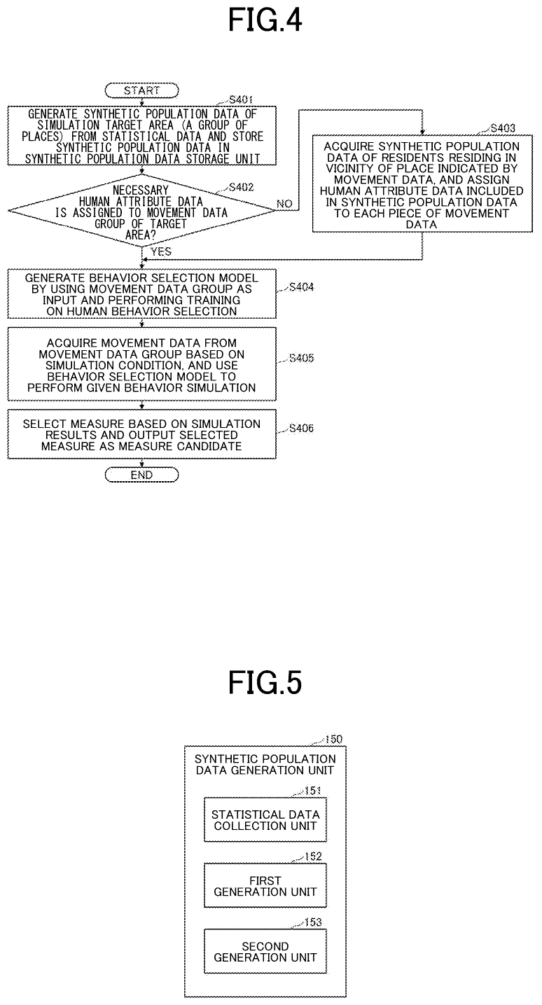

Next, an operation of the information processing apparatus 100 according to the present embodiment will be described with reference to FIG. 4. FIG. 4 is a flowchart illustrating the operation of the information processing apparatus.

The information processing apparatus 100 causes the synthetic population data generation unit 150 to generate synthetic population data of a target area and stores the synthetic population data in the synthetic population data storage unit 110 (step S401). The target area may be input by a user or the like of the information processing apparatus 100.

The generated synthetic population data includes first synthetic population data and second synthetic population data. Details of step S401 will be described later.

Subsequently, the information processing apparatus 100 causes the movement data attribute assignment unit 160 to reference the movement data storage unit 120 and the attribute-assigned movement data storage unit 130 and determine whether human attribute data is assigned to a movement data group that includes a departure place or a destination in the target area (step S402).

If it is determined that human attribute data is not assigned in step S402, the movement data attribute assignment unit 160 acquires the synthetic population data of the target area including the departure place or the destination indicated by the movement data group from the synthetic population data storage unit 110. Then, the movement data attribute assignment unit 160 assigns human attribute data included in the acquired synthetic population data to the movement data group, stores the data as attribute-assigned movement data in the attribute-assigned movement data storage unit 130 (step S403), and proceeds to step S404 described below.

The information processing apparatus 100 causes the behavior selection model generation unit 170 to generate a behavior selection model 141 by using the attribute-assigned movement data of the target area as an input, and stores the behavior selection model 141 in the model storage unit 140 (step S404).

Subsequently, the information processing apparatus 100 causes the simulation unit 180 to acquire attribute-assigned movement data based on a simulation condition input by the user or the like of the information processing apparatus 100. The simulation condition may be, for example, a date and time or the like. Then, the simulation unit 180 inputs the acquired attribute-assigned movement data into the behavior selection model 141, performs a simulation, and acquires simulation results (step S405).

The simulation unit 180 according to the present embodiment may perform, for example, a people flow simulation on a structure of a road that is different from the current structure. In this case, the structure of the road may be input as a simulation condition. When such a simulation is performed, changes in the flow of people (traffic conditions), the degree of congestion, the amount of carbon dioxide emission, and the like with respect to the different structure of the road can be acquired as simulation results.

Subsequently, the information processing apparatus 100 causes the measure search unit 190 to select a measure based on the simulation results and output the selected measure as a measure candidate (step S406).

In the present embodiment, a measure candidate may be selected by aggregating the opinions of various stakeholders. Stakeholders have various points of interest such as the amount of carbon dioxide emission, the degree of congestion, and a construction budget for road structure change. Therefore, in the present embodiment, the user or the like of the information processing apparatus 100 may specify important points determined based on the points of interest of the stakeholders, and cause a process of selecting a measure to be performed. Specifying important points may be performed by displaying the simulation results and allowing the user of the information processing apparatus 100 to view the simulation results and input important points.

In the example of FIG. 4, steps S401 to S406 are described as a series of steps, but the present invention is not limited thereto. Generation of synthetic population data in step S401 and generation of a behavior selection model 141 in step S404 of FIG. 4 may be performed at independent timings.

In the present embodiment, because synthetic population data including first synthetic population data and second synthetic population data is used to perform a simulation, the accuracy of the simulation can be improved.

Next, the synthetic population data generation unit 150 according to the present embodiment will be described. FIG. 5 is a diagram illustrating functions of the synthetic population data generation unit.

The synthetic population data generation unit 150 according to the present embodiment includes a statistical data collection unit 151, a first generation unit 152, and a second generation unit 153.

The statistical data collection unit 151 acquires various statistical data 1. The first generation unit 152 generates synthetic population data (first synthetic population data) of residents of a target area of a simulation, which is estimated from statistical data of the residents of the target area among the statistical data 1.

The second generation unit 153 identifies the residences and the number of travelers who visited the target area from statistical data of the travelers among the statistical data 1, and acquires first synthetic population data corresponding to each of the travelers from first synthetic population data of an area including the residences of the travelers. The second generation unit 153 adds information indicating a pseudo residence in the target area to the first synthetic population data corresponding to each of the travelers, and generates synthetic population data (second synthetic population data) of pseudo residents in the target area. Details of the second generation unit 153 will be described later.

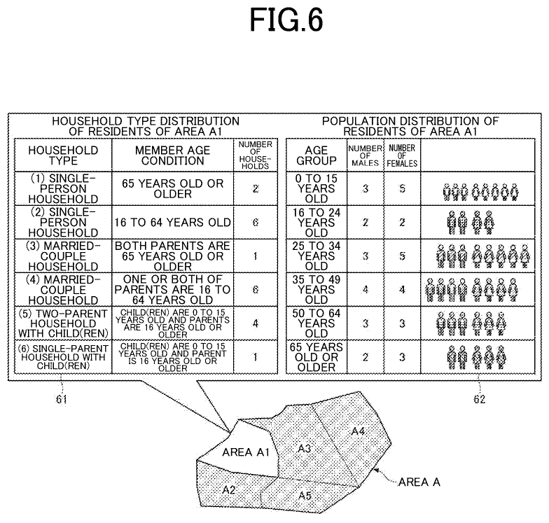

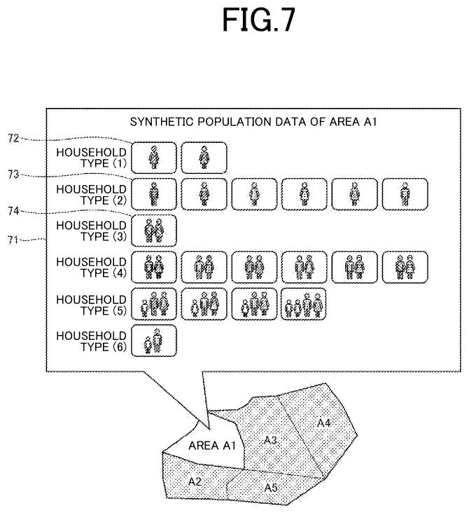

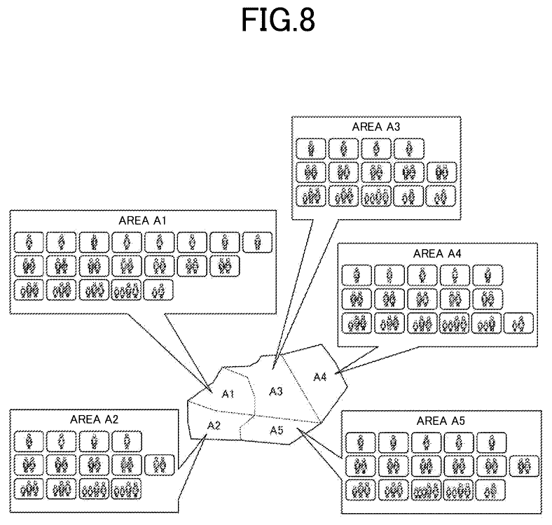

Next, an outline of generation of first synthetic population data by the first generation unit 152 will be described with reference to FIG. 6 to FIG. 8. FIG. 6 is a first diagram illustrating generation of first synthetic population data. FIG. 7 is a second diagram illustrating the generation of the first synthetic population data. FIG. 8 is a third diagram illustrating the generation of the first synthetic population data.

FIG. 6 illustrates an example of statistical data of an area A1 included in an area A. Each of statistical data 61 and statistical data 62 illustrated in FIG. 6 is, for example, statistical data based on a census, and is an example of statistical data acquired by the statistical data collection unit 151.

The statistical data 61 is data indicating a household group, and indicates the household types of households to which residents of the area A1 belong and the distribution of the households per attribute. A household type is one of attributes of a household, and may indicate, for example, the number of members constituting the household and an age group. Specifically, for example, household type 1 is defined as a household with one member and an age group of 65 years or older, household type 2 is defined as a household with one member and an age group of 16 to 64 years or younger, household type 3 is defined as a household with a married couple, both of whom are in an age group of 65 years or older, and so on.

From the statistical data 61, it can be seen that there are two households of the household type 1, six households of the household type 2, and one household of the household type 3.

The statistical data 62 is data indicating groups of members constituting the households, and indicates the distribution of population per age group and sex of the residents of the area A1. In the present embodiment, data indicating the age group and sex of each resident as in the statistical data 62 is human attribute data.

From the statistical data 62, it can be seen that three male residents and five female residents are in an age group of 0 to 15 years old, two male residents and two female residents are in an age group of 16 to 24 years old, three male residents and five female residents are in an age group of 25 to 34 years old, and so on.

Further, the statistical data collection unit 151 according to the present embodiment may acquire various kinds of statistical data not illustrated in FIG. 6. Specifically, for example, the statistical data collection unit 151 may collect statistical data aggregated according to various attributes of residents through cross-tabulation or the like. Such various attributes of a resident become a part of human attribute data. The human attribute data includes, in addition to age group and sex, household type to which the resident belongs, purpose (leisure or visiting acquaintances), place to stay (hotel or camping), travel type (whether the resident stays overnight), ownership of a private car, annual household income, and the like.

FIG. 7 schematically illustrates first synthetic population data of the area A1 generated by the first generation unit 152.

First synthetic population data 71 illustrated in FIG. 7 is data obtained by assigning the data of the groups of members constituting the households to data indicating the households and further associating household attributes and human attributes with the data indicating the households and the data of the groups of members constituting the households.

In other words, the first synthetic population data 71 is data in which household types (household attributes) in the area A1 are associated with human attribute data of the members belonging to the households based on the statistical data 61 and the statistical data 62. In FIG. 7, age group and sex are indicated as the human attribute data.

In FIG. 7, a mark 72 indicates a female who is 65 years old or older and belongs to the “household type 1”, a mark 73 indicates a male who is 16 to 24 years old and belongs to the household type 2″, and a mark 74 indicates a married couple, both of whom are 65 years old or older and belong to and the “household type 3”.

As described above, first synthetic population data according to the present embodiment is data in which household types are associated with human attribute data of members of households.

FIG. 8 illustrates a state in which first synthetic population data of each of an area A2 to an area A5 is generated based on statistical data of each of the area A2 to the area A5.

In this manner, the first generation unit 152 according to the present embodiment generates first synthetic population data for each area from statistical data.

Further, the first generation unit 152 according to the present embodiment generates first synthetic population data of areas other than the areas A1 to A5, and stores the data in the synthetic population data storage unit 110.

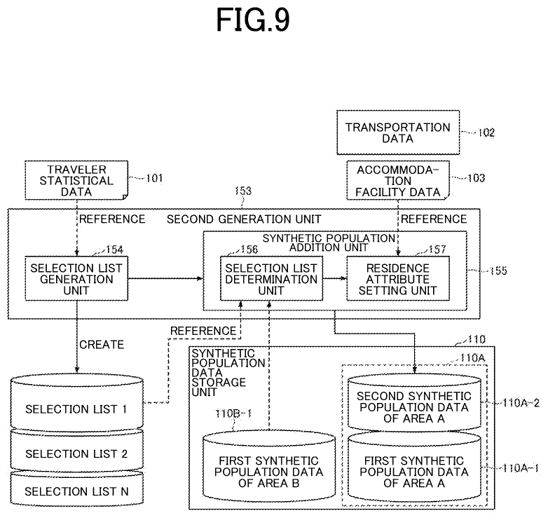

Next, the second generation unit 153 according to the present embodiment will be described with reference to FIG. 9. FIG. 9 is a diagram illustrating functions of the second generation unit.

The second generation unit 153 includes a selection list generation unit 154 and a synthetic population addition unit 155, and generates second synthetic population data.

First, the selection list generation unit 154 will be described. The selection list generation unit 154 according to the present embodiment identifies an area including residences of travelers based on traveler statistical data 101 of the target area among the statistical data 1 collected by the statistical data collection unit 151.

The target area is defined as the “area A”, and the area including the residences of the travelers who visited the area A is defined as an “area B”. The selection list generation unit 154 acquires first synthetic population data corresponding to the travelers from first synthetic population data 110B-1 of the area B based on the traveler statistical data 101.

Further, the selection list generation unit 154 assigns travel types to the first synthetic population data corresponding to the travelers based on the traveler statistical data 101. A travel type may be, for example, information indicating whether a traveler is on a day trip, or information indicating the number of nights and a place to stay if the traveler stays overnight, and may be identified from the traveler statistical data 101.

The selection list generation unit 154 will be described further below.

The selection list generation unit 154 according to the present embodiment references the traveler statistical data 101, acquires first synthetic population data corresponding to travelers, and generates a selection list for adding travel types.

The selection list includes information indicating conditions for first synthetic population data corresponding to travelers and the number of travelers for each travel type. In other words, the selection list includes information identifying household types to which travelers belong and human attribute data of the travelers, and information indicating the number of travelers for each travel type.

The selection list generation unit 154 may generate a plurality of selection lists from the traveler statistical data 101. Specifically, for example, the selection list generation unit 154 may generate a selection list for each of various statistical data included in the traveler statistical data 101. By using a plurality of selection lists to perform a simulation, the accuracy of the simulation can be improved.

As will be described later, the traveler statistical data 101 according to the present embodiment may include, for example, traveler statistical data 101-1 aggregated for each attribute of travelers who visited an area as a travel destination, and traveler statistical data 101-2 aggregated for each travel type of the travelers who visited the area as the travel destination.

The traveler statistical data 101-1 may be data obtained by aggregating, for example, the number of travelers by sex, the number of travelers by age group, the number of individual travelers, the number of group travelers, and the like, for each of residences of the travelers who visited the area as the travel destination. The traveler statistical data 101-2 may be data obtained by aggregating, for example, the number of overnight travelers, the number of day-trip travelers, the distribution of the number of travelers per number of nights of stay, and the like, for travelers who visited the area as the travel destination.

In addition, the selection list generation unit 154 may randomly determine the type of statistical data to be referenced when generating a selection list, and may also determine attributes of travelers to be included in the selection list as appropriate.

In the example of FIG. 9, the selection list generation unit 154 generates selection list 1 to selection list N. In the following description, the selection list 1 is a selection list generated by referencing the traveler statistical data 101-1, and is information indicating conditions for first synthetic population data corresponding to travelers. In addition, in the following description, the selection list 2 is a selection list generated by referencing the traveler statistical data 101-2, and is information indicating the number of travelers for each travel type.

Next, the synthetic population addition unit 155 will be described. The synthetic population addition unit 155 according to the present embodiment identifies places serving as pseudo residences of travelers in the target area A based on transportation data 102, accommodation facility data 103, first synthetic population data corresponding to the travelers, and travel types assigned to the first synthetic population data.

Then, the synthetic population addition unit 155 obtains second synthetic population data 110A-2 by adding information indicating the identified places to human attribute data included in the first synthetic population data corresponding to the travelers. Further, the synthetic population addition unit 155 obtains synthetic population data 110A of the target area A by adding the second synthetic population data 110A-2 to first synthetic population data 110A-1 of the target area A stored in the synthetic population data storage unit 110.

The synthetic population addition unit 155 will be further described below. The synthetic population addition unit 155 includes a selection list determination unit 156 and a residence attribute setting unit 157.

The selection list determination unit 156 determines a selection list to be referenced from among selection lists generated by the selection list generation unit 154. Further, the selection list determination unit 156 acquires first synthetic population data corresponding to travelers from the synthetic population data storage unit 110 based on the determined selection list. The selection list determination unit 156 may randomly determine a selection list to be referenced.

The residence attribute setting unit 157 references the determined selection list, the transportation data 102, and the accommodation facility data 103, and assigns travel types of the travelers to the first synthetic population data corresponding to the travelers.

Further, the residence attribute setting unit 157 identifies places serving as pseudo residences of the travelers in the target area A from the transportation data 102, the accommodation facility data 103, and the travel types, and adds information indicating the identified places to human attribute data included in the first synthetic population data corresponding to the travelers, thereby obtaining second synthetic population data 110A-2.

That is, the second synthetic population data 110A-2 is synthetic population data obtained by adding places indicating pseudo residences of the travelers in the target area to human attribute data included in first synthetic population data of an area including the residences of the travelers.

In the present embodiment, a pseudo residence of a traveler may be in the vicinity of a place where the traveler enters or exits or a place where the traveler stays overnight within the target area A.

The place where the traveler enters or exits within the target area A may be, for example, a location where a mode of transportation connecting the residence of the traveler and the target area enters or exits. The location where the mode of transportation enters or exits may be a location where a station or a stop of a mode of transportation is located, a place where an interchange of an expressway is located, or the like.

The residence attribute setting unit 157 may create and reference a location list indicating a list of locations where travelers enter or exit by referencing the transportation data 102. Further, the location list may also include a list of places where travelers stay overnight.

Each of the transportation data 102 and the accommodation facility data 103 may be information that is publicly available, and may be stored in advance in a storage area that can be referenced by the information processing apparatus 100.

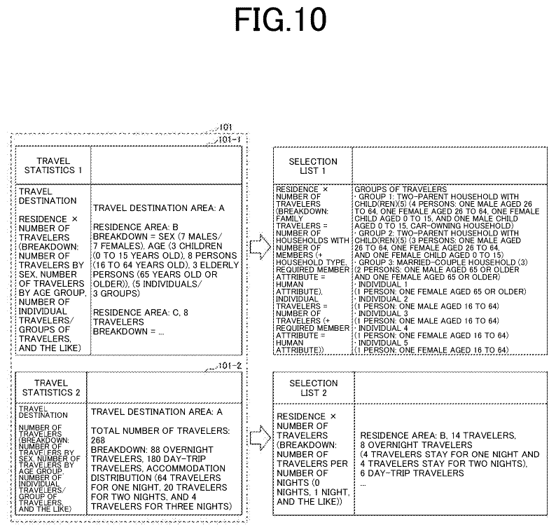

Next, various data handled by the synthetic population data generation unit 150 will be described referring to FIG. 10 to FIG. 14.

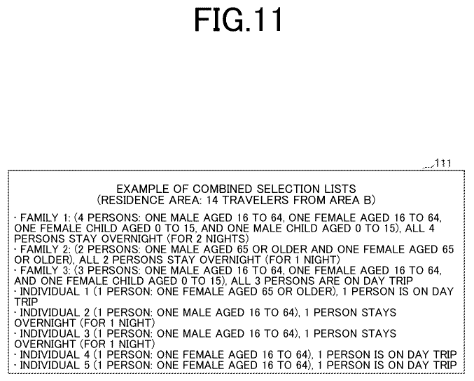

FIG. 10 is a first diagram illustrating selection lists. FIG. 11 is a second diagram illustrating the selection lists . . . .

The traveler statistical data 101-1 illustrated in FIG. 10 is data obtained by aggregating the number of travelers by sex, the number of travelers by age group, the number of individual travelers, the number of group travelers, and the like, with respect to travelers whose travel destination is the area A and whose residence is the area B. The traveler statistical data 101-2 is data obtained by aggregating the number of overnight travelers, the number of day-trip travelers, the distribution of the number of travelers per number of nights of stay, and the like, with respect to travelers whose travel destination is the area A.

The selection list 1 illustrated in FIG. 10 is generated by referencing the traveler statistical data 101-1, and is information indicating conditions for first synthetic population data corresponding to travelers among the first synthetic population data 110B-1 of the area B where the travelers reside.

Specifically, as the conditions for first synthetic population data corresponding to travelers, the selection list 1 indicates that there are a group of household type 5 “two parents with child (ren)” (consisting of 4 persons, including a male in an age group of 26 to 64 years old, a female in an age group of 26 to 64 years old, a female child in an age group of 0 to 15 years old, and a male child in an age group of 0 to 15 years old), a group of the household type 5 “two parents with child (ren)” (consisting of 3 persons, including a male in an age group of 26 to 64 years old, a female in an age group of 26 to 64 years old, and a female child in an age group of 0 to 15 years old), a group of the household type 3 “married-couple” (consisting of 2 persons, including a male in an age group of 65 years old or older and a female in an age group of 65 years old or older), and the like.

The selection list 2 illustrated in FIG. 10 is generated by referencing the traveler statistical data 101-2, and indicates the number of travelers for each travel type in the area A.

Specifically, the selection list 2 indicates that there are eight travelers staying overnight in the area A, of which four travelers stay for one night and four travelers stay for two nights, and there are six day-trip travelers.

Statistical data included in the traveler statistical data 101 according to the present embodiment is not limited to the example illustrated in FIG. 10. The traveler statistical data 101 may include, for example, statistical data obtained by aggregating the number and attributes of travelers for each event held at a specific time in the target area A.

Information 111 illustrated in FIG. 11 is information including information indicated in the selection list 1 and information indicated in the selection list 2. That is, the information 111 is information including the conditions for first synthetic population data corresponding to travelers and the number of travelers for each travel type.

In the present embodiment, first synthetic population data corresponding to travelers is acquired based on the information 111, and travel types are assigned to the first synthetic population data corresponding to the travelers.

In the present embodiment, the selection list 1 and the selection list 2 are separately generated from the traveler statistical data 101, and the first synthetic population data corresponding to the travelers is acquired based on the information 111 indicated by the selection lists, and the travel types are assigned to the first synthetic population data; however, the present invention is not limited thereto.

In the present embodiment, the information 111 may be acquired directly from the traveler statistical data 101 without creating the selection lists.

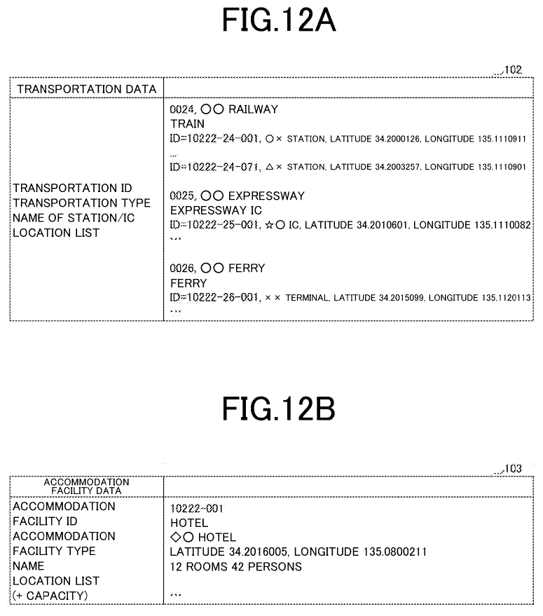

FIG. 12A is a diagram illustrating transportation data. FIG. 12B is a diagram illustrating accommodation facility data. The transportation data 102 may include, as information items, a transportation ID for identifying a mode of transportation, a transportation type indicating the type of the transportation, the name and the location of a station, an interchange, or the like.

The accommodation facility data 103 may include an accommodation facility ID for identifying an accommodation facility, an accommodation facility type indicating the type of the accommodation facility, the name and the location of the accommodation facility, and the capacity of the accommodation facility.

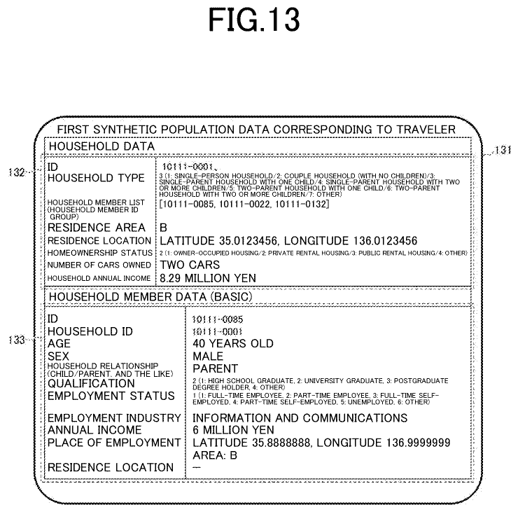

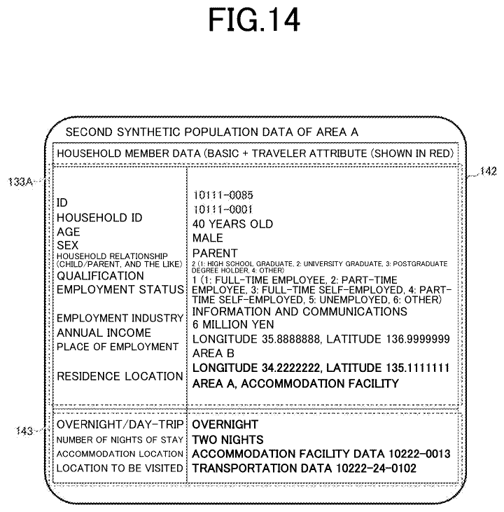

Next, first synthetic population data corresponding to a traveler and second synthetic population data of the target area A will be described referring to FIG. 13 and FIG. 14.

FIG. 13 is a diagram illustrating an example of first synthetic population data corresponding to a traveler. First synthetic population data 131 illustrated in FIG. 13 is an example of first synthetic population data corresponding to a traveler, acquired from the synthetic population data storage unit 110 based on the selection list 1.

In other words, the first synthetic population data 131 illustrated in FIG. 13 is an example of first synthetic population data acquired from the first synthetic population data 110B-1 stored in the synthetic population data storage unit 110.

The first synthetic population data 131 includes household attribute data 132 indicating attributes of a household to which the traveler belongs and human attribute data 133 of the traveler.

The household attribute data 132 includes, as information items, an ID for identifying the traveler, a household type, a list of IDs of members constituting the household, a residence area of the household, a residence location, and the like. In this example, because the residence of the traveler is in the area B, it is indicated that the residence area of the household is the area B.

The human attribute data 133 of the traveler includes, as information items, an ID for identifying the traveler, a household ID for identifying the household to which the traveler belongs, age, sex, qualifications, annual income, place of employment, a residence location, and the like.

Further, in the state of FIG. 13, because the values of the residence location are set in the household attribute data 132, the values of the residence location are not set in the human attribute data 133 of the traveler. Further, in the example of FIG. 13, a travel type is not added.

In the present embodiment, a travel type is added to the first synthetic population data 131 corresponding to the traveler by referencing the selection list 2. Further, in the present embodiment, second synthetic population data is obtained by adding information indicating a pseudo residence location of the traveler to the first synthetic population data 131 based on the travel type, the transportation data 102, and the accommodation facility data 103.

More specifically, in the present embodiment, the travel type of the traveler and the pseudo residence location of the traveler are added to the human attribute data 133 included in the first synthetic population data 131 corresponding to the traveler.

FIG. 14 is a diagram illustrating an example of second synthetic population data. Second synthetic population data 142 illustrated in FIG. 14 is an example of second synthetic population data 110A-2 of the area A stored in the synthetic population data storage unit 110.

The second synthetic population data 142 includes human attribute data 133A of the traveler, and the human attribute data 133A includes travel attribute data 143 including the travel type. Although not illustrated in FIG. 14, the second synthetic population data 142 may include the household attribute data 132.

The travel attribute data 143 illustrated in FIG. 14 includes, as information items, the travel type indicating a day trip or an overnight trip, the number of nights of stay, an accommodation location, a location to be visited, and the like. In the present embodiment, because the travel type included in the travel attribute data 143 indicates an overnight trip, a location of an accommodation facility is set as a pseudo residence of the traveler. Specifically, in the human attribute data 133A, the location of the accommodation facility in an area A3 is set as a value of the residence location.

The second synthetic population data according to the present embodiment is synthetic population data obtained by adding, as the pseudo residence of the traveler, the place in the target area to the human attribute data included in the first synthetic population data corresponding to the traveler.

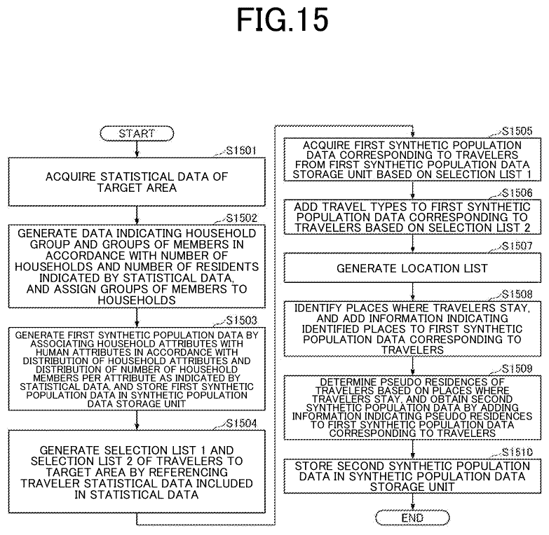

Next, a process performed by the synthetic population data generation unit 150 according to the present embodiment will be described with reference to FIG. 15.

FIG. 15 is a flowchart illustrating the process performed by the synthetic population data generation unit. The process in FIG. 15 corresponds to details of step S401 of FIG. 4.

The synthetic population data generation unit 150 according to the present embodiment causes the statistical data collection unit 151 to collect statistical data 1 of a target area (step S1501).

Subsequently, the synthetic population data generation unit 150 causes the first generation unit 152 to generate data indicating a household group and data indicating groups of members constituting households in accordance with the number of the households and the number of residents indicated by the statistical data 1 and, and assigns the data of the groups of members constituting the households to data indicating the households (step S1502). Subsequently, the first generation unit 152 generates first synthetic population data by associating household types (household attributes) with human attribute data in accordance with the distribution of the household types and the distribution of the number of the members constituting the households per attribute as indicated by the statistical data 1, and stores the first synthetic population data in the synthetic population data storage unit 110 (step S1503).

Subsequently, the synthetic population data generation unit 150 causes the selection list generation unit 154 of the second generation unit 153 to generate a selection list 1 and a selection list 2 by referencing traveler statistical data 101 included in the statistical data 1 (step S1504).

The selection list generation unit 154 may generate a selection list by weighting statistical values indicated by the traveler statistical data 101 or by using discretionary value adjustments. Specifically, the selection list generation unit 154 may generate a selection list by changing weights applied to population statistics values.

Further, if the traveler statistical data 101 has unclear values, the selection list generation unit 154 may generate a plurality of selection lists by randomly selecting values corresponding to the unclear values. The traveler statistical data 101 having unclear values is, for example, traveler statistical data in which sex is unknown.

Subsequently, the selection list generation unit 154 acquires first synthetic population data corresponding to travelers from first synthetic population data of an area including residences of the travelers based on the selection list 1 (step S1505).

Subsequently, the selection list generation unit 154 adds travel types of the travelers to human attribute data included in the first synthetic population data corresponding to the travelers based on the selection list 2 (step S1506). At this time, the selection list generation unit 154 may add modes of transportation used by the travelers, together with the travel types. For example, if human attribute data of a traveler includes information indicating that the traveler owns a private car, information indicating that the traveler's mode of transportation is a private car may be added to the human attribute data of the traveler.

Subsequently, the second generation unit 153 causes the residence attribute setting unit 157 to generate a location list by referencing the transportation data 102 and the accommodation facility data 103 (step S1507).

In the present embodiment, the location list may be generated in consideration of availability for each traveler's residence. Specifically, for example, stations, interchanges, and the like that that would cause an unnecessary detour on a route from each traveler's residence to the target area may be excluded from the location list.

Subsequently, the residence attribute setting unit 157 identifies places where the travelers stay in the target area according to the travel types of the travelers, and adds information indicating the identified places to the human attribute data included in the first synthetic population data corresponding to the travelers (step S1508). The information indicating the places where the travelers stay is information indicating accommodation facilities where the travelers stay or locations where the travelers visit.

For example, if the travel type of a traveler is a day trip, the residence attribute setting unit 157 may identify a location where a mode of transportation connecting the residence of the traveler to the target area enters or exits as a place where the traveler stays. In addition, if the travel type of the traveler is an overnight trip, the residence attribute setting unit 157 may identify an accommodation facility of the traveler as a place where the traveler stays.

In the present embodiment, a place to stay within the target area differs according to the travel type of each traveler. Thus, a place indicating a pseudo residence of a traveler can be made closer to the actual residence of the traveler.

Further, if the travel type of the traveler is an overnight trip, the residence attribute setting unit 157 may determine a place where the traveler stays according to the number of nights of stay. For example, if the number of nights of stay is one night, the residence attribute setting unit 157 may set a location where a mode of transportation connecting the residence of the traveler to the target area enters or exits as a place to stay, similar to the case where the travel type is a day trip. If the number of nights of stay is two nights or more, the residence attribute setting unit 157 may set an accommodation facility as a place to stay.

In the present embodiment, by determining a place where a traveler stays as described above, it is possible to set the place determined based on the behavior pattern of the traveler within the target area, as a pseudo residence of the traveler.

Subsequently, the residence attribute setting unit 157 determines pseudo residences of the travelers based on the places where the travelers stay, and obtains second synthetic population data of the target area by adding information indicating the pseudo residences to the human attribute data included in the first synthetic population data corresponding to the travelers (step S1509).

The pseudo residences of the travelers may be places where the travelers stay or places near the places where the traveler stay.

Subsequently, the residence attribute setting unit 157 stores the second synthetic population data in the synthetic population data storage unit 110 (step S1510).

The process illustrated in FIG. 15 may be performed each time the process illustrated in FIG. 4 is performed, and second synthetic population data may be stored in the synthetic population data storage unit 110 each time the process illustrated in FIG. 15 is performed.

In this manner, a plurality of sets of second synthetic population data of the target area is stored in the synthetic population data storage unit 110. That is, a plurality of sets of second synthetic population data generated according to the selection lists determined by the selection list determination unit 156 are stored in the synthetic population data storage unit 110.

In the present embodiment, when a simulation is executed by the simulation unit 180, the user of the information processing apparatus 100 may select second synthetic population data to be used for the simulation from among the plurality of sets of the second synthetic population data stored in the synthetic population data storage unit 110.

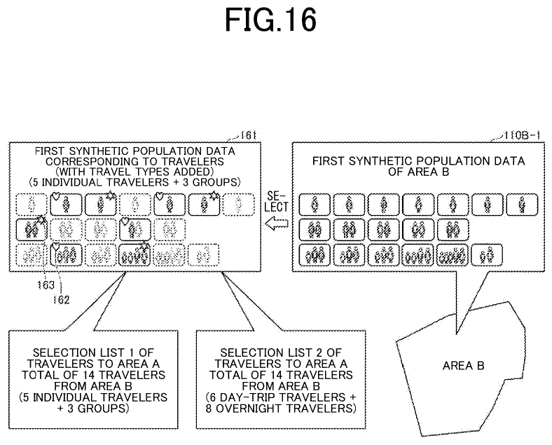

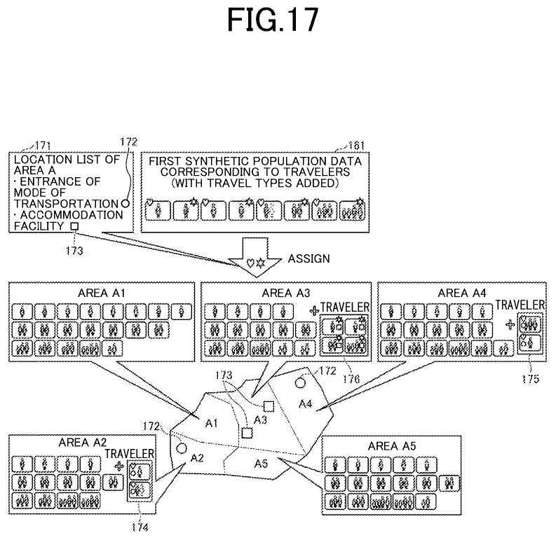

A process of generating second synthetic population data will be schematically described below with reference to FIG. 16 and FIG. 17.

FIG. 16 is a first diagram illustrating generation of second synthetic population data. In FIG. 16, first synthetic population data 161 corresponding to travelers is first synthetic population data corresponding to travelers that is acquired from the first synthetic population data 110B-1 of the area B based on the selection list 1 and in which travel types are added to human attribute data based on the selection list 2. In other words, the first synthetic population data 161 corresponding to the travelers is first synthetic population data corresponding to travelers with the travel types added.

Specifically, for example, the selection list 1 indicates that the travelers from the area B to the area A include three traveler groups and five individual travelers. Therefore, the second generation unit 153 acquires, as the first synthetic population data corresponding to the travelers, first synthetic population data based on conditions indicated by the selection list 1 from the first synthetic population data 110B-1 of the area B.

Next, the second generation unit 153 adds travel types to human attribute data included in the first synthetic population data corresponding to the travelers based on conditions indicated by the selection list 2.

In the example of FIG. 16, a mark 162 indicates that a travel type is a day trip, and a mark 163 indicates that a travel type is an overnight trip.

For example, in the first synthetic population data 161 corresponding to the travelers, it can be seen that two travelers among the individual travelers are day-trip travelers, and one group consisting of three persons among the three traveler groups is a day-trip traveler group. In addition, in the first synthetic population data 161 corresponding to the travelers, it can be seen that one person belonging to a household type with two members is a day-trip traveler.

Further, in the first synthetic population data 161 corresponding to the travelers, it can be seen that a group of two persons and a group of four persons are overnight travelers, and two of the individual travelers are overnight travelers.

As described above, in the present embodiment, the travel types are assigned to the first synthetic population data corresponding to the travelers, acquired from the first synthetic population data of the area including the residences of the travelers, so as to satisfy the selection list 2.

FIG. 17 is a second diagram illustrating the generation of the second synthetic population data. FIG. 17 illustrates an example in which pseudo residences of the travelers are added to the human attribute data of the first synthetic population data 161 corresponding to the travelers with the travel types added, based on the first synthetic population data 161 corresponding to the travelers with the travel types added and a location list 171 created from the transportation data 102.

The location list 171 of FIG. 17 may include a list of locations where travelers enter or exit in the area A and a list of accommodation facilities where travelers stay.

In FIG. 17, a location where traveler(s) enter or exit in the area A is marked with a mark 172, and a location of an accommodation facility in the area A is marked with a mark 173. Specifically, each of the area A2 and the area A4 is marked with one mark 172, and the area A3 is marked with two marks 173.

Therefore, in the area A, it is estimated that travelers who stay in the areas A2 and A4 are likely to be day-trip travelers, and travelers who stay in the area A3 are likely to be overnight travelers.

Therefore, in the present embodiment, information indicating locations where travelers enter or exit is added, as information indicating pseudo residences, to human attribute data included in first synthetic population data having a travel type of a day trip, thereby obtaining second synthetic population data of the target area A.

Further, information indicating locations of accommodation facilities is added, as information indicating pseudo residences, to human attribute data included in first synthetic population data having a travel type of an overnight trip, thereby obtaining second synthetic population data of the target area A.

Specifically, in FIG. 17, synthetic population data 174 and synthetic population data 175, in each of which information indicating locations where travelers enter or exit is added as information indicating pseudo residences, are second synthetic population data of the area A2 and second synthetic population data of the area A4, respectively.

In addition, in FIG. 17, synthetic population data 176, in which information indicating locations of accommodation facilities of travelers is added as information indicating pseudo residences, is second synthetic population data of the area A3.

In the present embodiment, second synthetic population data of the target area A is obtained by setting pseudo residences in the first synthetic population data 161 corresponding to the travelers, based on the location list 171 of the target area A and travel attributes set in the first synthetic population data 161 corresponding to the travelers.

In other words, in the present embodiment, first synthetic population data of travelers can be added to synthetic population data of the target area as second synthetic population data of the target area including the same human attribute data as residents of the target area. Therefore, according to the present embodiment, a social simulation taking travelers into account can be performed, and the accuracy of the simulation can be improved.

The present disclosure is not limited to specific embodiments, and various modifications and changes can be made without departing from the scope of the claims.

All examples and conditional language provided herein are intended for pedagogical purposes of aiding the reader in understanding the invention and the concepts contributed by the inventors to further the art, and are not to be construed as limitation to such specifically recited examples and conditions, nor does the organization of such examples in the specification relate to a showing of superiority and inferiority of the invention. Although one or more embodiments of the present invention have been described in detail, it should be understood that various changes, substitutions, and alterations could be made hereto without departing from the spirit and scope of the invention.

What is claimed is:

1. A data generation method, executed by a computer, for generating data to be used in a simulation, the data generation method comprising:
identifying, by the computer, a travel type of a traveler who visits a target area of the simulation by referencing statistical data;
adding, by the computer, information indicating a place where the traveler stays in the target area, identified according to the travel type of the traveler, to human attribute data of the traveler; and
adding, by the computer, the human attribute data of the traveler, to which the information indicating the place where the traveler stays is added, to a human attribute data group of residents of the target area, the human attribute data group being used in the simulation.

2. The data generation method according to claim 1, wherein the travel type is information indicating whether the traveler stays overnight in the target area or the traveler is on a day trip in the target area.

3. The data generation method according to claim 1, wherein, in a case where the traveler stays overnight in the target area, the information indicating the place where the traveler stays is information indicating a location of an accommodation facility where the traveler stays in the target area.

4. The data generation method according to claim 1, wherein, in a case where the travel type is a day trip in the target area, the information indicating the place where the traveler stays is information indicating a location where a mode of transportation connecting a residence of the traveler and the target area enters or exits.

5. The data generation method according to claim 1, wherein the human attribute data of the traveler is acquired from human attribute data of residents of an area including a residence of the traveler based on information identifying human attribute data of travelers and information indicating a number of travelers per travel type, the information identifying the human attribute data of the travelers and the information indicating the number of travelers being generated from the statistical data.

6. The data generation method according to claim 3, wherein, in a case where the travel type of the traveler indicates that the traveler stays overnight in the target area, the place where the traveler stays is determined, according to a number of nights the traveler stays, to be either the location of the accommodation facility where the traveler stays or a location where a mode of transportation connecting a residence of the traveler and the target area enters or exits.

7. A computer-readable recording medium having stored therein a data generation program for causing a computer to execute a process comprising:
identifying a travel type of a traveler who visits a target area of a simulation by referencing statistical data;
adding information indicating a place where the traveler stays in the target area, identified according to the travel type of the traveler, to human attribute data of the traveler; and
adding the human attribute data of the traveler, to which the information indicating the place where the traveler stays is added, to a human attribute data group of residents of the target area, the human attribute data group being used in the simulation.
